(19) United States
(12) Patent Application Publication
(10) Pub. No.: US 2009/0304118 A1
(43) Pub. Date: Dec. 10, 2009

(54) DIVERSITY RECEIVING DEVICE

(76) Inventor: Dou Yuanzhu, Fukushima-ken (JP)

Correspondence Address: BRINKS HOFER GILSON & LIONE, P.O. BOX 10395, CHICAGO, IL, 60610, US

(21) Appl. No.: 12/476,542

(22) Filed: Jun. 2, 2009

(30) Foreign Application Priority Data
Jun. 9, 2008 (JP) 2008-150106

(51) Int. Cl. H04L 27/06; H04B 1/06

(52) U.S. Cl. 375/340; 455/275

(57) ABSTRACT

A diversity receiving device includes a plurality of mixers which are provided to correspond to antennas arranged so as to be separated from each other and each of which multiplies a radio frequency signal output from the corresponding antenna by a local oscillation signal to modulate the radio frequency signal into an intermediate frequency signal; a reference signal source that generates a reference signal; a plurality of local oscillating units which are provided to correspond to the plurality of mixers, and each of which generates a local oscillation signal having a frequency corresponding to the phase of the reference signal and supplies the local oscillation signal to the corresponding mixer; a filter circuit that is provided between the reference signal source and the plurality of local oscillating units and changes the phase of the reference signal supplied to all the local oscillating units or the local oscillating units other than one local oscillating unit according to a predetermined passband frequency; an adder that combines the intermediate frequency signals output from the mixers; and a phase control circuit that detects a phase difference between the intermediate frequency signals output from the plurality of mixers and controls the passband frequency of the filter circuit such that there is no phase difference between the intermediate frequency signals.

### CROSS REFERENCE TO RELATED APPLICATIONS

The present invention contains subject matter related to and claims priority to Japanese Patent Application No. 2008-150106 filed in the Japanese Patent Office on Jun. 9, 2008, the entire contents of which is incorporated herein by reference.

### BACKGROUND

1. Technical Field

The present invention relates to a diversity receiving device that receives, for example, terrestrial digital broadcast signals using a diversity scheme.

2. Related Art

An OFDM receiving device having a diversity receiving function, for example, has been proposed which receives OFDM modulation signals transmitted from a terrestrial digital broadcasting system. In the OFDM receiving device according to the related art, the frequencies of a plurality of OFDM modulation signals received by a plurality of antennas are modulated, and the frequency-modulated signals are digitized. Then, the phases of the digitized signals are corrected and diversity combining is performed on the phase-corrected digitized signals. Therefore, the size of an integrated circuit that performs the digital process for diversity combining is very large, and thus power consumption increases.

Therefore, an OFDM receiving device has been proposed in which an analog circuit performs diversity combining (for example, see JP-A-2003-18123). As shown in FIG. 6, in the OFDM receiving device disclosed in JP-A-2003-18123, OFDM modulation signals are received by antennas 1 and 6, and pass through RF filters 2 and 7. Then, the OFDM modulation signals are amplified by low noise amplifiers 3 and 8 and the amplified OFDM modulation signals are input to mixers 4 and 9. The OFDM modulation signals input to the mixers 4 and 9 are mixed with a first local oscillation signal to be modulated into first intermediate frequency signals. The first intermediate frequency signal output from the mixer 4 and the first intermediate frequency signal output from the mixer 9 are input to an adder 12 through first IF bandpass filters 5 and 10, respectively. The adder performs diversity combining on the first intermediate frequency signals. The combined first intermediate frequency signal is input to a mixer 13 and the input signal is mixed with a second local oscillation signal supplied from a second local oscillator 14 to be modulated into a second intermediate frequency signal. The second intermediate frequency signal is input to an A/D converter 16 through a second IF bandpass filter 15, and the A/D converter 16 coverts the second intermediate frequency signal into a digital signal. The digital signal is demodulated by an OFDM demodulating unit 17. In addition, the digital signal is input to a power detecting unit 18. The power detecting unit 18 detects power in proportional to the level of the second intermediate frequency signal from the input digital signal, and the detected power is input to a phase control unit 19. The phase control unit 19 controls the phase of the first local oscillation signal of a local oscillating unit 21. In the local oscillating unit 21, one reference signal generated by a reference signal generating source 21e is input to two phase shifters 21f and 21g, and the phase shifters 21f and 21g control the phase of the reference signal in response to instructions from the phase control unit 19 and supply the phase-controlled reference signal to the corresponding PLL circuits 21c and 21d, respectively. The PLL circuits 21c and 21d set the oscillating frequencies of two local oscillators 21a and 21b, and the first local oscillation signals generated by the two local oscillators 21a and 21b are supplied to the corresponding mixers 4 and 9, respectively.

However, in the OFDM receiving device according to the related art, a general-purpose IC tends to include the A/D converter 16 and the OFDM demodulating unit 17 according to a standardized method. Therefore, it is preferable that an analog circuit be used to perform diversity combining, in order to achieve a general-purpose demodulating IC.

However, in the above-mentioned OFDM receiving device, since power is detected from the digital signal after diversity combining, the digital signal after diversity combining needs to be extracted from the demodulating IC for phase control. Therefore, it is necessary to change the configuration of the demodulating IC in order to perform diversity reception, which makes it difficult to achieve a general-purpose demodulating IC.

In addition, in the above-mentioned OFDM receiving device, the reference signal is input to the phase shifters 21f and 21g and the phase shifters control the phase of the reference signal. However, a phase control signal needs to be extracted from the demodulating IC. Therefore, a phase control response is delayed, and digital noise is likely to occur in the demodulating IC in the subsequent stage.

### SUMMARY

According to an aspect of the invention, a diversity receiving device includes: a plurality of mixers which are provided to correspond to antennas arranged so as to be separated from each other and each of which multiplies a radio frequency signal output from the corresponding antenna by a local oscillation signal to modulate the radio frequency signal into an intermediate frequency signal; a reference signal source that generates a reference signal; a plurality of local oscillating units which are provided to correspond to the plurality of mixers, and each of which generates a local oscillation signal having a frequency corresponding to the phase of the reference signal and supplies the local oscillation signal to the corresponding mixer; a filter circuit that is provided between the reference signal source and the plurality of local oscillating units and changes the phase of the reference signal supplied to all the local oscillating units or the local oscillating units other than one local oscillating unit according to a predetermined passband frequency; an adder that combines the intermediate frequency signals output from the mixers; and a phase control circuit that detects a phase difference between the intermediate frequency signals output from the plurality of mixers and controls the passband frequency of the filter circuit such that there is no phase difference between the intermediate frequency signals.

According to this configuration, the phase difference between the intermediate frequency signals output from a plurality of mixers is detected from the intermediate frequency signals, and the passband frequency of the filter circuit is controlled on the basis of the phase difference. Therefore, it is possible to control the phase of the reference signal supplied to the local oscillating unit to match the phases of the intermediate frequency signals. As a result, it is possible to reduce influence on the amplitude of the intermediate frequency signal, as compared to a configuration that directly controls the phase of the intermediate frequency signal, and thus improve a receiving performance. In addition, an analog circuit of the receiving device can perform diversity combining. Therefore, a demodulating integrated circuit in the subsequent stage does not need to acquire information for controlling the phase of the intermediate frequency signal. As a result, it is possible to achieve a general-purpose demodulating IC.

### BRIEF DESCRIPTION OF THE DRAWINGS

FIG. 1 is a diagram illustrating the configuration of a diversity receiving device according to an embodiment of the invention;

FIG. 2A is a diagram illustrating the configuration of an LC parallel resonant circuit provided in a filter, and FIG. 2B is a diagram illustrating the configuration of an LC series resonant circuit provided in the filter;

FIG. 3 is a diagram illustrating the circuit configuration of a local oscillating unit;

FIG. 4A is a diagram illustrating the simulation results of the relationship between the phase rotation of a reference signal and the amplitude of an intermediate frequency signal, FIG. 4B is a diagram illustrating the simulation results of a comparative example;

FIG. 5 is a diagram illustrating the circuit configuration of the comparative example of directly controlling the phase of an intermediate frequency signal; and

FIG. 6 is a diagram illustrating the configuration of an OFDM receiving device according to the related art.

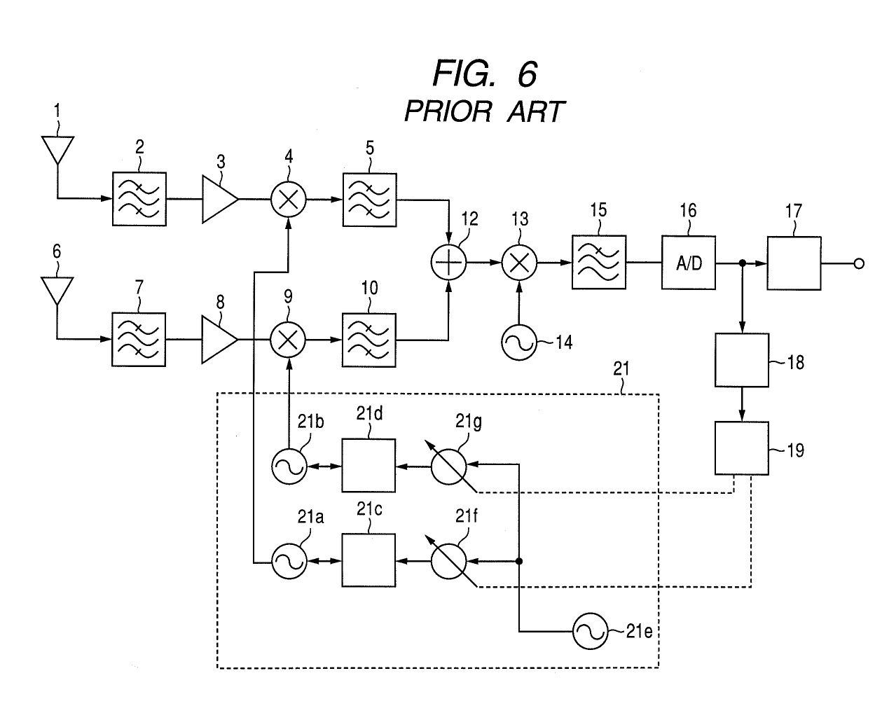

### DESCRIPTION OF EXEMPLARY EMBODIMENTS

Hereinafter, exemplary embodiments of the invention will be described in detail with reference to the accompanying drawings.

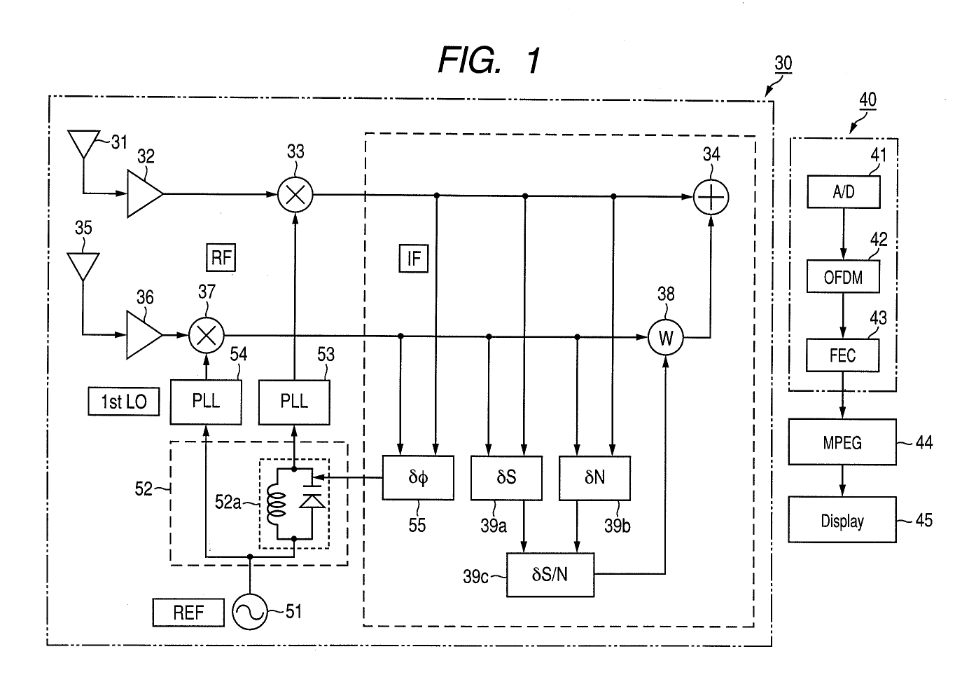

FIG. 1 is a diagram illustrating the configuration of a diversity receiving device according to an embodiment of the invention, and shows an example of a configuration in which a plurality of antennas arranged so as to be separated from each other are used to receive OFDM modulation signals of terrestrial digital broadcast signals by a diversity receiving method.

In a diversity receiving device 30 according to this embodiment, an OFDM modulation signal received by an antenna 31 is input to a low noise amplifier 32 through an RF filter (not shown). The low noise amplifier 32 amplifies the OFDM modulation signal and inputs the amplified signal to a first mixer 33. The first mixer 33 mixes the input signal with a local oscillation signal to modulate the input signal into an intermediate frequency signal, and inputs the intermediate frequency signal to an adder 34 for diversity combining. Meanwhile, an OFDM modulation signal received by an antenna 35 is input to a multiplier 38 for level control through an RF filter (not shown), a low noise amplifier 36, and a second mixer 37. When the antenna 31 is of a first receiving channel and the antenna 35 is of a second receiving channel, a signal level detector 39a detects the signal levels of the first and second receiving channels, and a noise level detector 39b detects the noise levels of the first and second receiving channels. Then, a coefficient calculating unit 39c determines a coefficient on the basis of the signal levels and the noise levels and inputs the coefficient to the multiplier 38. The multiplier 38 multiplies the OFDM modulation signal of the second receiving channel by the coefficient to control the level of the OFDM modulation signal. Then, the OFDM modulation signal whose level is controlled is input to the adder 34, and the adder 34 performs diversity combining on the signal, and outputs the diversity-combined OFDM modulation signal to an OFDM demodulating IC 40.

In the OFDM demodulating IC 40, an A/D converter 41 converts the diversity-combined OFDM modulation signal into a digital signal, and an OFDM demodulator 42 demodulates the digital television signal. An error correction circuit 43 corrects the error of the digital television signal using a forward error correction method. The error-corrected digital television signal is input to an MPEG decoder 44, and the MPEG decoder 44 decodes the input signal, and outputs the decoded signal to an image processing IC or a display 45.

In this embodiment, a reference signal source 51 provided in an analog circuit generates a reference signal Ref, and the reference signal is input in parallel to a first local oscillating unit 53 and a second local oscillating unit 54 through a filter circuit 52 that can separately control the phase of the first receiving channel and the phase of the second receiving channel. In this embodiment, an LC resonant circuit 52a controls only the phase of the reference signal Ref supplied to the first local oscillating unit 53, but the phase of the reference signal Ref supplied to the second local oscillating unit 54 is not controlled. However, the phases of the reference signals Ref supplied to the first and second local oscillating units 53 and 54 may be appropriately controlled. A phase control circuit 55 supplies a phase control DC voltage signal to the filter circuit 52. The phase control circuit 55 detects a phase difference between the intermediate frequency signal output from the first mixer 33 of the first receiving channel and the intermediate frequency signal output from the second mixer 37 of the second receiving channel, and generates a DC voltage signal that is controlled to have a small phase difference. The LC resonant circuit 52a includes a variable capacitance element whose capacitance varies depending on a voltage applied, and is configured such that a resonance frequency varies depending on a DC voltage signal that is applied as a tuning voltage to the variable capacitance element.

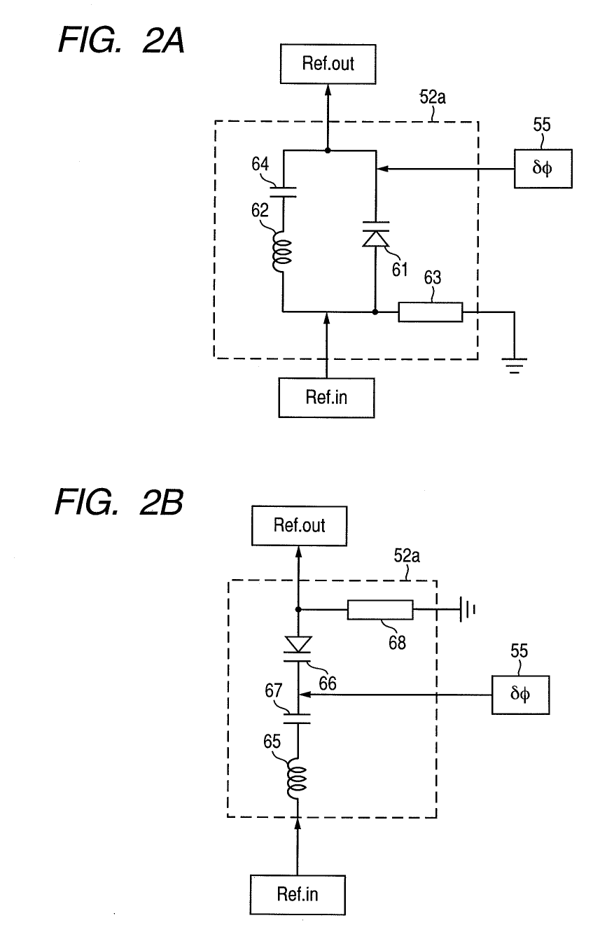

FIGS. 2A and 2B are diagrams illustrating examples of the circuit configuration of the LC resonant circuit 52a. Specifically, FIG. 2A shows the circuit configuration of an LC parallel resonant circuit, and FIG. 2B shows the circuit configuration of an LC series resonant circuit. In the LC parallel resonant circuit shown in FIG. 2A, a varactor diode 61, serving as a variable capacitance element, is connected in parallel to an inductor 62, and the reference signal Ref is supplied to a connection point between an anode of the varactor diode 61 and one end of the inductor 62. In addition, the phase-controlled reference signal Ref is output from a connection point between a cathode of the varactor diode 61 and the other end of the inductor 62. The anode of the varactor diode 61 is connected to the ground through a high-impedance resistor 63, and a DC voltage signal is supplied from the phase control circuit 55 to the cathode of the varactor diode 61. In addition, the DC voltage signal is supplied between a DC cut capacitor 64 and the cathode of the varactor diode 61.

In the LC series resonant circuit shown in FIG. 2B, an inductor 65 is connected in series to a varactor diode 66. The reference signal Ref is supplied to one end of the inductor 65, and the phase-controlled reference signal Ref is output from an anode of the varactor diode 66. The anode of the varactor diode 66 is connected to the ground through a high-impedance resistor 68, and a DC voltage signal is supplied from the phase control circuit 55 to a connection point between the other end of the inductor 65 and a cathode of the varactor diode 66. In addition, the DC voltage signal is supplied between a DC cut capacitor 67 and the cathode of the varactor diode 66.

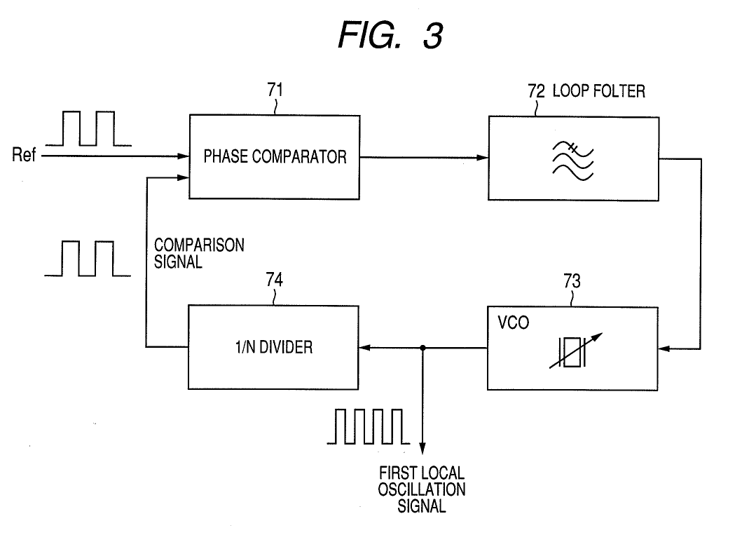

FIG. 3 is a diagram illustrating the circuit configuration of the first local oscillating unit 53. The second local oscillating unit 54 has the same circuit configuration as the first local oscillating unit 53, and thus a description thereof will be omitted.

In the first local oscillating unit 53, the reference signal Ref and a comparison signal are input to a phase comparator 71, and the phase comparator 71 compares the phase of the reference signal Ref with the phase of the comparison signal and outputs a pulse signal corresponding to the phase difference to a loop filter 72. The loop filter 72 may be an integrating circuit or an LPF. The phase difference signal output from the phase comparator 71 is a pulse signal, and an AC component is removed from the pulse signal to obtain a control voltage for the local oscillator 73. The control voltage output from the loop filter 72 is input to a local oscillator 73. Then, an output frequency, serving as a first local oscillation signal, varies. The output frequency signal of the local oscillator 73 is input to a 1/N divider 74. That is, a signal having a frequency that is 1/N of the oscillating frequency of the frequency local oscillator 73 is fed back to the phase comparing circuit 71 as the comparison signal, thereby obtaining a VCO output that is synchronously oscillated at a frequency that is N times higher than the reference frequency (Ref=fIN), that is, at a frequency of N×fIN.

Next, the indirect phase control of an intermediate frequency signal by the filter circuit 52 controlling the phase of the reference signal Ref will be described.

When diversity combining is performed on an OFDM modulation signal in an intermediate frequency band, it is necessary to rotate the phase of the intermediate frequency signal of the first receiving channel by a maximum angle of ±180° relative to the phase of the intermediate frequency signal of the second receiving channel. In FIG. 1, the phase of the intermediate frequency signal of the second receiving channel is fixed, and the phase of the intermediate frequency signal of the first receiving channel is rotated.

In the example shown in FIG. 2B, the LC resonant circuit 52a passes only a frequency component that is identical to a resonance frequency of the reference signal Ref supplied from the reference signal source 51, and outputs the frequency component to the first local oscillating unit 53. The resonance frequency of the LC resonant circuit 52a varies depending on the level of a tuning voltage (DC voltage signal) Therefore, it is possible to rotate the phase of the reference signal Ref (Δφ_{ref}) by changing the resonance frequency of the LC resonant circuit 52a.

In the first local oscillating unit 53, the reference signal Ref is compared with the comparison signal having a frequency obtained by dividing the frequency of the first local oscillation signal by N, and the loop filter 72 converts the phase difference into a DC voltage phase difference signal. The oscillating frequency fLo of the local oscillator 73 is determined by the phase difference signal. Then, the first mixer 33 mixes the first local oscillation signal determined by the phase of the reference signal Ref and the division number N of the divider 74 with the OFDM modulation signal (fRF) of an RF signal to convert the frequency of the OFDM modulation signal into an intermediate frequency IF (IF=f_{RF}−fLo).

The phase rotation (Δφ_{if}) of the intermediate frequency signal with respect to the phase rotation (Δφ_{ref}) of the reference signal Ref can be defined as follows:

Δφ_{if}=Δφ_{ref}×fLo/Ref

(where Ref indicates the frequency of a reference signal, and fLo indicates the frequency of a local oscillation signal).

A value of fLo/Ref corresponds to the division number N of the divider 74. For example, when an intermediate frequency LO is 600 MHz and the reference signal Ref has a frequency of 4 MHz, the division number N is 150. When the phase of the reference signal Ref is rotated by Δφ_{ref}=2°, the phases of the oscillating frequency and the intermediate frequency IF are rotated by Δφ_{if}=300° according to the above-mentioned expression. That is, even when the filter circuit 52 slightly rotates the phase of the reference signal Ref, the phase of the intermediate frequency IF whose frequency is modulated by the first local oscillation signal generated on the basis of the reference signal Ref is greatly rotated.

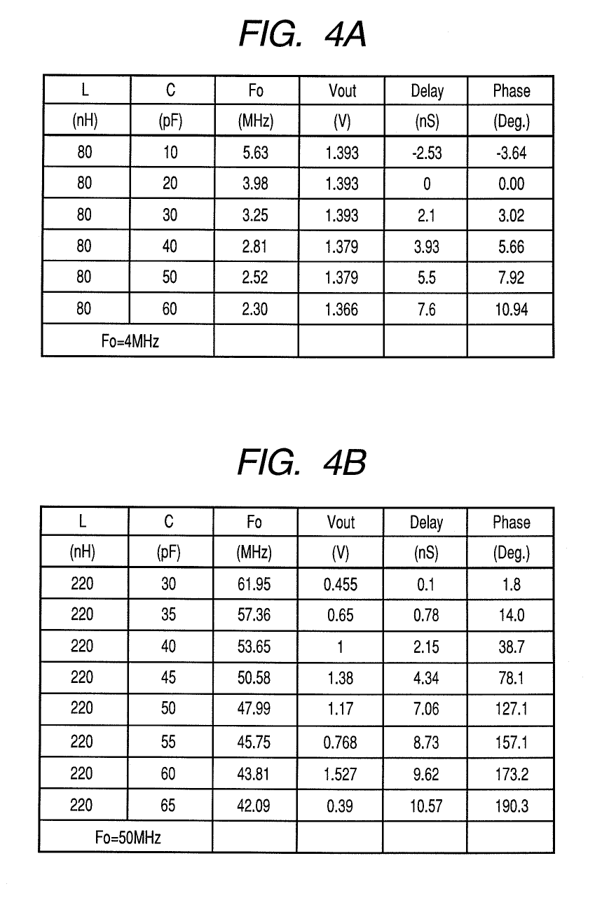

FIG. 4A is a diagram illustrating the simulation results of the relationship between the phase rotation (Δφ_{ref}) of the reference signal Ref and the amplitude (Vout) of the intermediate frequency signal. The frequency Fo of the reference signal Ref input to the LC resonant circuit 52a is 4 MHz. The DC voltage signal supplied to the varactor diode 61 varied to change the capacitance C of the LC resonant circuit 52a from 10 pF to 60 pF. As a result, the resonance frequency [Fo] of the LC resonant circuit 52a was changed from 5.63 MHz to 2.30 MHz. In this case, the phase [Phase] of the reference signal (resonance frequency Fo) was changed in the range of −3.64 to 10.94, and the amplitude [Vout] of the intermediate frequency signal was changed in the range of 1.393 V to 1.379 V.

As can be seen from the simulation results, it is possible to rotate the phase of the intermediate frequency signal by ±180° or more, with little change in the amplitude [Vout] of the intermediate frequency signal, by rotating the phase [Phase] of the reference signal (resonance frequency Fo) by about 13°.

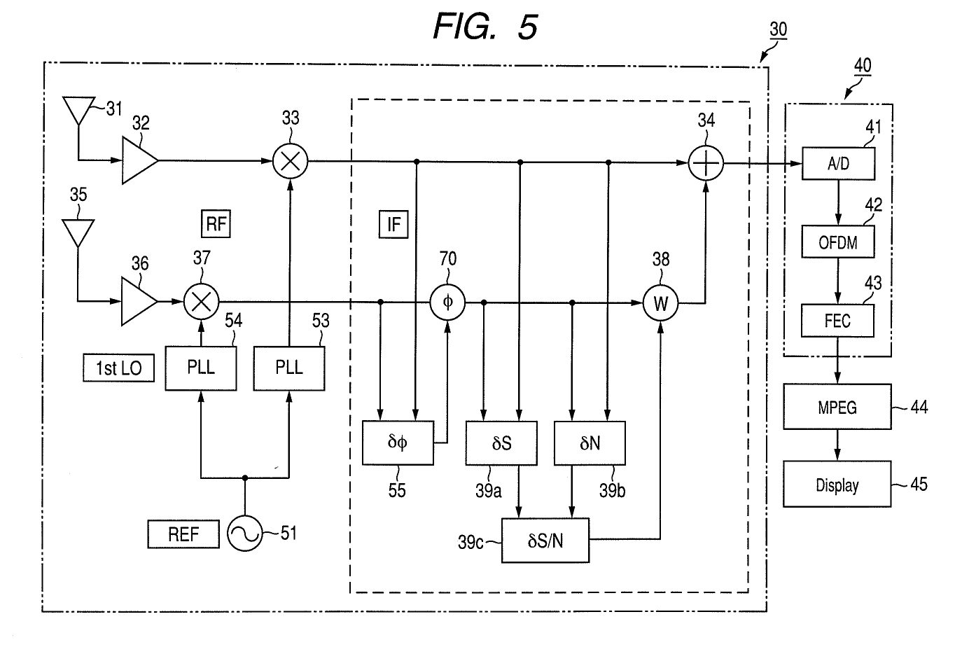

FIG. 5 is a diagram illustrating the circuit configuration of a comparative example of directly controlling the phase of the intermediate frequency signal. In the comparative example, a phase control filter circuit 70 is provided in the rear stage of the second mixer 37 in the second receiving channel, and the filter circuit 70 directly controls the phase of the intermediate frequency signal. The intermediate frequency signal input from the second mixer 37 is input as an input intermediate frequency signal to an input terminal of the filter circuit 70, and the filter circuit 70 rotates the phase of the intermediate frequency signal and outputs the intermediate frequency signal as an output intermediate frequency signal from an output terminal to the multiplier 38. The filter circuit 70 is configured as the LC resonant circuit shown in FIG. 2A in order to be suitable for the configuration of the simulation circuit shown in FIG. 4A.

FIG. 4B is a diagram illustrating the simulation results of the relationship between the phase rotation of the intermediate frequency signal and the amplitude (Vout) of the output intermediate frequency signal according to the comparative example shown in FIG. 5. The frequency Fo of the input intermediate frequency signal input to the filter circuit 70 (LC resonant circuit 52a) is 50 MHz. The DC voltage signal supplied to the varactor diode 61 varied to change the capacitance C of the LC resonant circuit 52a from 30 pF to 65 pF. As a result, the resonance frequency [Fo] of the LC resonant circuit 52a was changed from 61.95 MHz to 42.09 MHz. It is possible to achieve a phase rotation of about 180° by changing the phase [Phase] of the input intermediate frequency signal in the range of 1.8 to 190.3. However, in this case, there is a large variation in the amplitude [Vout] of the intermediate frequency signal from 0.39 V to 1.38 V.

As can be seen from the simulation results, in the direct phase control of the intermediate frequency signal, the impedance of the filter circuit 70 varies greatly with a change in the resonance frequency, in order for the LC resonant circuit 52a to rotate the phase of the intermediate frequency signal by 180°. Therefore, the amplitude of the intermediate frequency signal is greatly affected.

Next, the diversity receiving operation of the diversity receiving device 30 according to this embodiment will be described.

The phase control circuit 55 detects the phase difference between the phase of the intermediate frequency signal of the first receiving channel and the phase of the intermediate frequency signal of the second receiving channel, and outputs a DC voltage signal corresponding to the phase difference to the LC resonant circuit 52a of the filter circuit 52. The phase of the reference signal Ref input to the first local oscillating unit 53 is controlled by the resonance frequency of the LC resonant circuit 52a. The resonance frequency is controlled such that the phase difference detected by the phase control circuit 55 is zero. The reference signal Ref rotated such that the phases of the intermediate frequency signals of the two channels are identical to each other is supplied to the first local oscillating unit 53, and the first local oscillating unit 53 compares the phase of the reference signal with the phase of the comparison signal. Then, the first local oscillating frequency controlled by an oscillating frequency corresponding to the phase difference is input to the first mixer 33. The first mixer 33 performs frequency conversion with the first local oscillating frequency corresponding to the phase difference. On the other hand, the reference signal Ref is supplied to the second local oscillating unit 54 without any phase rotation, and the second local oscillation signal generated on the basis of the reference signal Ref is input to the second mixer 37. The second mixer 37 performs frequency conversion with the second local oscillating frequency. The coefficient multiplier 38 controls the level of the intermediate frequency signal of the second receiving channel with a coefficient that is determined on the basis of the signal levels and the noise levels between the channels. Then, the phase of the intermediate frequency signal of the first receiving channel is rotated such that the phases of the intermediate frequency signals of the first and second receiving channels are identical to each other, and the adder 34 performs diversity combining on the intermediate frequency signals. The output of the adder 34 is input as a diversity-combined reception signal to a general-purpose IC 40. The general-purpose IC 40 digitizes the signal and performs OFDM demodulation and error correction on the digitized signal.

According to this embodiment, the phase of the reference signal Ref supplied to at least one local oscillating unit 53 is controlled by the LC resonance filter circuit 52a such that the phases of two intermediate frequency signals to be subjected to diversity combining are identical to each other. Therefore, it is possible to significantly reduce influence on the amplitude of the intermediate frequency signal, as compared to a configuration in which an intermediate frequency signal is input to a resonant circuit to directly control the phase thereof, thereby improving a receiving performance. In addition, the phase difference between two intermediate frequency signals is detected, and the phase difference is used to control the resonance frequency of the LC resonance filter circuit 52a. Therefore, it is not necessary to acquire amplitude data after diversity combining from the general-purpose IC 40, and an analog circuit performs phase control for diversity combining. Therefore, it is not necessary to change the configuration of the general-purpose IC 40 for diversity combining, and it is possible to easily achieve a general-purpose OFDM demodulating IC.

In addition, a self-completion phase control circuit is used in which the phase of the reference signal Ref is directly extracted from an IF signal and the LC resonance filter circuit 52a controls the phase of the reference signal Ref in order to perform diversity combining. Therefore, it is possible to prevent the influence of noise of a digital demodulating IC in the subsequent stage while improving a process speed, as compared to a method of controlling a phase shifter while receiving feedback information after demodulation.

In the above-described embodiment, the OFDM receiving device is given as an example. However, the invention may be similarly applied to broadcast signals (including analog signals) or transmission signals other than the OFDM modulation signal.

The invention can be applied to a receiver that receives terrestrial digital broadcast signals using a diversity scheme.

What is claimed is:

1. A diversity receiving device comprising:
a plurality of mixers which are provided to correspond to antennas arranged so as to be separated from each other and each of which multiplies a radio frequency signal output from the corresponding antenna by a local oscillation signal to modulate the radio frequency signal into an intermediate frequency signal;
a reference signal source that generates a reference signal;
a plurality of local oscillating units which are provided to correspond to the plurality of mixers, and each of which generates a local oscillation signal having a frequency corresponding to the phase of the reference signal and supplies the local oscillation signal to the corresponding mixer;
a filter circuit that is provided between the reference signal source and the plurality of local oscillating units and changes the phase of the reference signal supplied to all the local oscillating units or the local oscillating units other than one local oscillating unit according to a predetermined passband frequency;
an adder that combines the intermediate frequency signals output from the mixers; and
a phase control circuit that detects a phase difference between the intermediate frequency signals output from the plurality of mixers and controls the passband frequency of the filter circuit such that there is no phase difference between the intermediate frequency signals.

2. The diversity receiving device according to claim 1,
wherein the filter circuit includes a parallel resonant circuit having an inductor and a variable capacitance element connected in parallel to each other, and
a tuning voltage corresponding to the phase difference between the intermediate frequency signals is applied to the variable capacitance element to control the passband frequency.

3. The diversity receiving device according to claim 1,
wherein each of the local oscillating units includes:
a divider that divides the frequency of the local oscillation signal by N;
a phase comparator that compares the phase of the reference signal output from the reference signal source with the phase of a comparison signal obtained from the divider dividing the frequency of the local oscillation signal by N; and
a local oscillator that generates the local oscillation signal, and changes the frequency thereof according to the phase difference detected by the phase comparator such that there is no phase difference, thereby stabilizing an oscillating frequency.

4. The diversity receiving device according to claim 1,
wherein the antennas receive OFDM modulation signals, and
an OFDM demodulating integrated circuit is connected to the subsequent stage of the adder.
